(19) United States
(12) Patent Application Publication
(10) Pub. No.: US 2024/0082715 A1
(43) Pub. Date: Mar. 14, 2024

(54) QUANTIFYING SPECTATOR INTERACTION ACCOUNTS IN A TIMEFRAME

(71) Applicant: Tencent Technology (Shenzhen) Company Limited, Shenzhen (CN)

(72) Inventors: Dong YU, Shenzhen (CN); Xiangqian DANG, Shenzhen (CN)

(73) Assignee: Tencent Technology (Shenzhen) Company Limited, Shenzhen (CN)

(21) Appl. No.: 18/389,555

(22) Filed: Nov. 14, 2023

Related U.S. Application Data
(63) Continuation of application No. PCT/CN2022/135002, filed on Nov. 29, 2022.

(30) Foreign Application Priority Data
Mar. 1, 2022 (CN) 202210194400.5

(51) Int. Cl. A63F 13/533; A63F 13/44; A63F 13/822; A63F 13/86

(52) U.S. Cl. CPC A63F 13/533; A63F 13/44; A63F 13/822; A63F 13/86

(57) ABSTRACT

A spectator interaction method includes displaying an interactive control for a first spectator account watching an online battle, the interactive control configured to trigger an interaction between the first spectator account and one or more spectator accounts currently watching the online battle. The method further includes displaying first interactive content in response to receiving a trigger operation on the interactive control. The method further includes displaying a quantity of spectator accounts corresponding to the first interactive content, the quantity of spectator accounts including accounts that have interacted with the first interactive content, and accounts that have interacted with second interactive content triggered by a second spectator account. The second interactive content being a same interactive content type as the first interactive content.

### RELATED APPLICATIONS

This application is a continuation of International Application No. PCT/CN2022/135002, filed on Nov. 29, 2022, which claims priority to Chinese Patent Application No. 202210194400.5, entitled “SPECTATOR INTERACTION METHOD AND APPARATUS, DEVICE, STORAGE MEDIUM, AND PROGRAM PRODUCT” filed on Mar. 1, 2022. The disclosures of the prior applications are hereby incorporated by reference in their entirety.

### FIELD OF THE TECHNOLOGY

Embodiments of this application relate to the field of Internet technologies, including a spectator interaction method and apparatus, a device, a storage medium, and a program product.

### BACKGROUND OF THE DISCLOSURE

With the development of computer technologies and networks, the development of online games is increasingly fast. At present, most online games support the spectator function, and users can watch the ongoing battle in real time through a spectator platform.

In related art, a plurality of users interact with each other mainly by transmitting text or voice messages to each other in a spectator process.

However, in the foregoing interaction process, interaction between users needs to rely on transmitting texts or voice messages, resulting in more frequent interactive operations in the spectator process, which reduces the efficiency of human-machine interaction while occupying more backend resources.

### SUMMARY

Embodiments of this application provide a spectator interaction method and apparatus, a device, a storage medium, and a program product, to save backend resources. The technical solutions are as follows.

In an embodiment, a spectator interaction method includes displaying an interactive control for a first spectator account watching an online battle, the interactive control configured to trigger an interaction between the first spectator account and one or more spectator accounts currently watching the online battle. The method further includes displaying first interactive content in response to receiving a trigger operation on the interactive control, the first interactive content having a display starting time point and a display ending time point. The first interactive content is display content transmitted to the one or more spectator accounts in a first spectator set. The method further includes displaying a quantity of spectator accounts corresponding to the first interactive content, the quantity of spectator accounts including one or more spectator accounts in the first spectator set that have interacted with the transmitted first interactive content, and including spectator accounts that have interacted with second interactive content triggered by a second spectator account between the display starting time point and the display ending time point. The second interactive content is a same interactive content type as the first interactive content.

In an embodiment, a spectator interaction apparatus includes processing circuitry configured to display an interactive control for a first spectator account watching an online battle, the interactive control being configured to trigger an interaction between the first spectator account and one or more spectator accounts currently watching the online battle. The processing circuitry is further configured to display first interactive content in response to receiving a trigger operation on the interactive control. The first interactive content has a display starting time point and a display ending time point, and the first interactive content is configured to be transmitted to the one or more spectator accounts in a first spectator set. The processing circuitry is further configured to display a quantity of spectator accounts corresponding to the displayed first interactive content, the quantity of spectator accounts including one or more spectator accounts in the first spectator set that have interacted with the transmitted first interactive content and spectator accounts that have interacted with second interactive content triggered by a second spectator account between the display starting time point and the display ending time point. The second interactive content is a same interactive content type as the first interactive content.

In an embodiment, a non-transitory computer-readable storage medium stores computer-readable instructions thereon, which, when executed by processing circuitry, cause the processing circuitry to perform a spectator interaction method. The method includes displaying an interactive control for a first spectator account watching an online battle, the interactive control configured to trigger an interaction between the first spectator account and one or more spectator accounts currently watching the online battle. The method further includes displaying first interactive content in response to receiving a trigger operation on the interactive control, the first interactive content having a display starting time point and a display ending time point. The first interactive content is display content transmitted to the one or more spectator accounts in a first spectator set. The method further includes displaying a quantity of spectator accounts corresponding to the first interactive content, the quantity of spectator accounts including one or more spectator accounts in the first spectator set that have interacted with the transmitted first interactive content, and including spectator accounts that have interacted with second interactive content triggered by a second spectator account between the display starting time point and the display ending time point. The second interactive content is a same interactive content type as the first interactive content.

The technical solutions provided in the embodiments of this application may include the following beneficial effects:

Same interactive content displayed on spectator interfaces of different spectator accounts is transmitted to some spectator accounts, a quantity of spectator accounts that respond to the same interactive content in a period of time is counted, and a specified response result is displayed in the spectator interfaces based on the quantity of spectator accounts, which saves computing resources of the backend while implementing interaction sharing among different spectator accounts.

### BRIEF DESCRIPTION OF THE DRAWINGS

FIG. 1 is a schematic diagram of an implementation environment according to an exemplary embodiment of this application.

FIG. 2 is a flowchart of a spectator interaction method according to an exemplary embodiment of this application.

FIG. 3 is a schematic diagram of an interface according to an exemplary embodiment of this application.

FIG. 4 is a schematic diagram of an interface according to another exemplary embodiment of this application.

FIG. 5 is a schematic diagram of an interface according to another exemplary embodiment of this application.

FIG. 6 is a flowchart of a spectator interaction method according to another exemplary embodiment of this application.

FIG. 7 is a flowchart of a sequence according to an exemplary embodiment of this application.

FIG. 8 is a flowchart of a spectator interaction method according to another exemplary embodiment of this application.

FIG. 9 is a flowchart of logic according to an exemplary embodiment of this application.

FIG. 10 is a structural block diagram of a spectator interaction apparatus according to an exemplary embodiment of this application.

FIG. 11 is a structural block diagram of a spectator interaction apparatus according to another exemplary embodiment of this application.

FIG. 12 is a structural block diagram of a terminal according to another exemplary embodiment of this application.

### DESCRIPTION OF EMBODIMENTS

In a related art, spectator accounts are supported to communicate with each other through voice messages, text messages, picture messages, and the like in a spectator interface. A communication platform may be a dialog box in the spectator interface. The spectator accounts are also supported to initiate relatively simple interactions in the spectator interface. For example, in a case that a spectator account is watching a game battle, and a battling party supported by the spectator account wins, the spectator account may initiate a cheering interaction, and a spectator account that receives the cheering interaction may respond to the cheering interaction. However, in a case that there are many spectator accounts that are simultaneously online in a battle, interactions with more information, such as voice messages, text messages, and picture messages, cannot be obtained quickly, and are low-efficient interaction manners. In addition, every spectator account may transmit interactive content, and a backend needs to repeatedly forward the interactive content and count a response result of each piece of interactive content. Therefore, more backend resources are occupied.

An embodiment of this application provides a spectator interaction method. A spectator account may transmit interactive content to some specified spectator accounts. In a period of time, in a case that same specified interactive content is transmitted by a plurality of spectator accounts, first, the specified spectator accounts do not receive the same specified interactive content repeatedly; second, the backend counts a quantity of all specified spectator accounts that respond to the specified interactive content in the period of time (the specified interactive content is same interactive content initiated by a plurality of spectator accounts in a period of time), and the backend transmits a response result to the spectator account based on the quantity of the specified spectator accounts. For example, in a period of time from the 0^{th} second to the 7^{th} second, a total of X accounts respond to a high-five interaction initiated by a spectator A. At the 4^{th} second, a spectator B initiates a same high-five interaction. In a period of time from the 4^{th} second to the 7^{th} second, a total of Y accounts respond to the high-five interaction initiated by the spectator B. In this case, in the period of time from the 0^{th} second to the 7^{th} second, a quantity of accounts that respond to the high-five interaction initiated by the spectator A includes: a quantity X of accounts that respond to the high-five interaction initiated by the spectator A and a quantity Y of accounts that respond to the high-five interaction initiated by the spectator B.

Interaction sharing is implemented in the foregoing manner of calculating a quantity of accounts that respond, which saves computing resources of the backend while improving the spectator interaction experience of users.

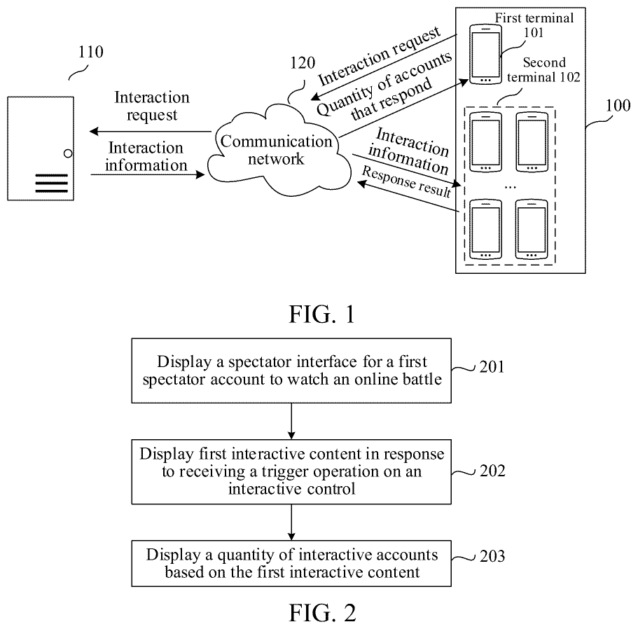

FIG. 1 is a schematic diagram of an implementation environment according to an exemplary embodiment of this application. As shown in FIG. 1, the implementation environment includes a terminal 100 and a server 110, and the terminal 100 includes a plurality of spectator terminals. In an embodiment, the plurality of spectator terminals are classified into a first terminal 101 and a second terminal 102. The first terminal 101 refers to a terminal that transmits interactive content, and the second terminal 102 refers to a terminal that receives the interactive content. The terminal 100 and the server 110 are connected by a communication network 120. FIG. 1 is described by using merely one first terminal 101 as an example.

In an embodiment of this application, an application with a spectator function is installed in the first terminal 101 and the second terminal 102. In an embodiment, the application includes a game application, a live streaming application, a shopping application, a social application, and the like. This is not limited in this embodiment. A first spectator account is logged in to the first terminal 101.

The first terminal 101 transmits an interaction request to the server 110. The interaction request includes interaction information. The interaction information includes at least first interactive content and moment information. The server 110 transmits the interaction information to some second terminals 102 in response to the interaction request. The second terminals 102 that receive the interaction information may respond to the interaction information, and feed back response results to the server 110. Based on the response results, the server 110 counts a quantity of accounts that respond and forwards, to the first terminal 101, the quantity of accounts that respond. The quantity of accounts that respond is displayed on a spectator page of the first terminal 101 and the second terminals 102 that respond to the interaction information. During a same period of time, in a case that there is a same interaction request transmitted by another first terminal 101, and correspondingly, there are other second terminals 102 that respond to the interaction request, the quantity of accounts that respond further includes a quantity of the other second terminals 102 that respond to the same interaction request.

In some embodiments, the terminal 100 may be a smartphone, a tablet computer, a notebook computer, a desktop computer, a smart household appliance, a smart in-vehicle terminal, a smart speaker, or the like, but is not limited thereto.

The server 110 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The cloud technology is an anchoring technology that unifies a series of resources, such as hardware, software, and networks, in a wide area network or a local area network to implement computing, storage, processing, and sharing of data.

In some embodiments, the communication network 120 may be a wired network, or may be a wireless network. This is not limited herein.

Information (including, but not limited to, user equipment information, user personal information, and the like), data (including, but not limited to, data for analysis, stored data, displayed data, and the like), and a signal involved in this application are all authorized by the user or fully authorized by each party, and collection, use, and processing of relevant data need to comply with relevant laws and regulations of relevant countries and regions.

The spectator interaction method provided in the embodiments of this application may be applied to at least the following application scenarios.

1. Spectator Interaction in an Online Game

A spectator module is provided in an online game. A user may select a battle in the spectator module to enter a spectator interface, to watch the battle in real time. An interactive control is displayed in the spectator interface of the game. For example, a spectator may click/tap the interactive control to trigger displaying interactive content and transmitting the interactive content to another spectator. The interactive content includes displaying text prompt information. The text prompt information includes a quantity of other spectators that respond to the interactive content. For example, “XX people high-five you” is displayed in the interactive content. The “XX people” herein includes all accounts that respond to a same interactive content in a period of time. In other words, the “XX people” includes a quantity of accounts that respond corresponding to an interaction initiated by a current account, and further includes a quantity of accounts that respond corresponding to a same interaction initiated by another account in an overlapping period of time. The interaction can be shared among different accounts in a simple interaction manner, which improves interactive experience of users on a spectator platform.

2. Spectator Interaction in a Live Match Streaming

During a live match streaming, a spectator user automatically enters a spectator mode, and users may independently initiate an interaction in a function interface of a discussion area or a spectator interface. Both the spectator user and a commentator user may initiate a simple interactive operation through an interactive control. For example, an applause interaction may be initiated in a case that an exciting game moment occurs. A quantity of accounts that respond to the applause interaction can be seen in the spectator interface in real time. The quantity of accounts that respond to the applause interaction is a total quantity of accounts that respond to all applause interactions initiated in this period of time. Through such a simple interaction, an interactive feeling of an offline game is restored as much as possible, and the users are brought with a feeling that everyone is applauding, which improves the spectator experience of the users.

The foregoing application scenarios are merely examples. Another application scenario of the spectator interaction method provided in the embodiments of this application is not limited herein.

With reference to the introduction and the implementation environment, FIG. 2 is a flowchart of a spectator interaction method according to an embodiment of this application. As shown in FIG. 2, the method includes the following steps:
Step 201: Display a spectator interface for a first spectator account to watch an online battle. For example, an interactive control is displayed for a first spectator account watching an online battle. The interactive control is configured to trigger an interaction between the first spectator account and one or more spectator accounts currently watching the online battle.

In an embodiment, the first spectator account refers to an account that logs in to a specified platform and that initiates an interaction. A platform function corresponding to the specified platform includes at least a spectator function. For example, in a case that the specified platform is implemented as an online game platform, the first spectator account is a player account that logs in to the online game platform for spectating. In a case that the specified platform is implemented as a live match streaming platform, the first spectator account is a user account that logs in to the platform for watching a live match streaming.

The online battle refers to a battle that is ongoing, or that is over, or that is ready to start on the specified platform. The online battle may be implemented as a game battle in an online game, a sports match, an e-sports match, a quiz competition, or the like. This is not limited in this embodiment.

The spectator interface refers to an interface that displays battle content of the online battle. The spectator interface includes an interactive control. The interactive control is configured to trigger an interaction with a spectator account that is watching the online battle. In an embodiment, the spectator interface further includes a spectator count display control. The spectator count display control is configured to display in real time a total quantity of accounts watching the online battle.

In an embodiment, the interactive control is displayed in the spectator interface. A display form of the interactive control includes temporarily displaying the interactive control as a pop-up window in the spectator interface, permanently displaying the interactive control in the spectator interface, and the like. For example, in a case that the interactive control is temporarily displayed in the spectator interface as a pop-up window, before the interactive control is displayed, the following is included: displaying an interactive button in the spectator interface; receiving a click/tap operation on the interactive button; and displaying the interactive control in the spectator interface in response to the click/tap operation.

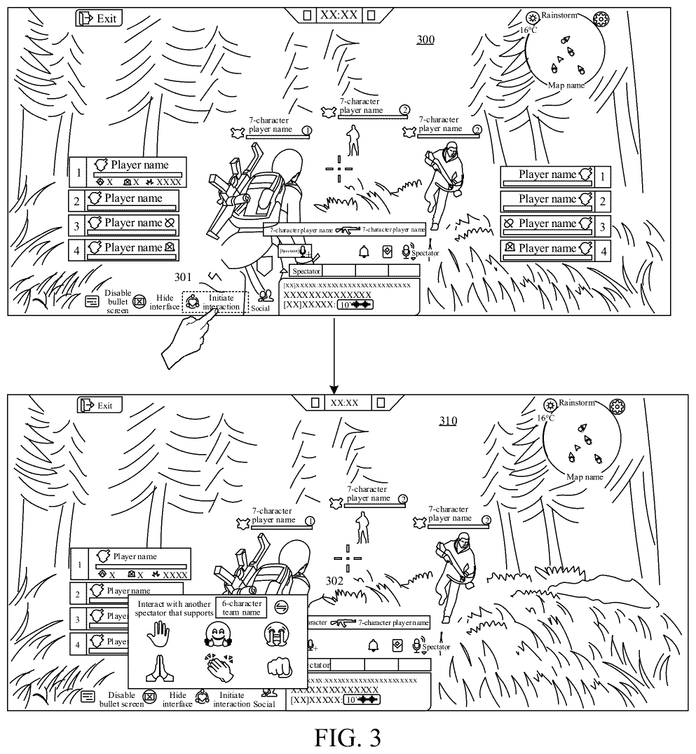

In an embodiment, the pop-up window is a pop-up window in a temporary status. The pop-up window is closed in a case that a region of the spectator interface outside the pop-up window is clicked/tapped. For example, referring to FIG. 3, an interactive pop-up window 302 is displayed in a spectator interface 310 in a case that an “Initiate interaction” button 301 in a spectator interface 300 is clicked/tapped. The interactive pop-up window 302 is closed in a case that a region of the spectator interface 310 outside the interactive pop-up window 302 is clicked/tapped.

For example, in a case that the specified platform is implemented as an online game platform, the first spectator account is implemented as a player account, and a display manner of the spectator interface includes at least one of the following manners:
1. A player participates in a game battle, and in a case that the player is eliminated before the game battle is over, the player selects a spectator mode to enter a spectator interface, to watch the game battle that is not over.
2. A player may not participate in a game battle, and select a game battle that is ongoing in a game battle channel, to enter a spectator interface, to watch the game battle.
Step 202: Display first interactive content in response to receiving a trigger operation on an interactive control. For example, first interactive content is displayed in response to receiving a trigger operation on the interactive control. The first interactive content has a display starting time point and a display ending time point, and the first interactive content is display content transmitted to one or more spectator accounts in a first spectator set.

The first interactive content corresponds to a display starting moment and a display ending moment. The first interactive content is transmitted to a spectator account in a first spectator set.

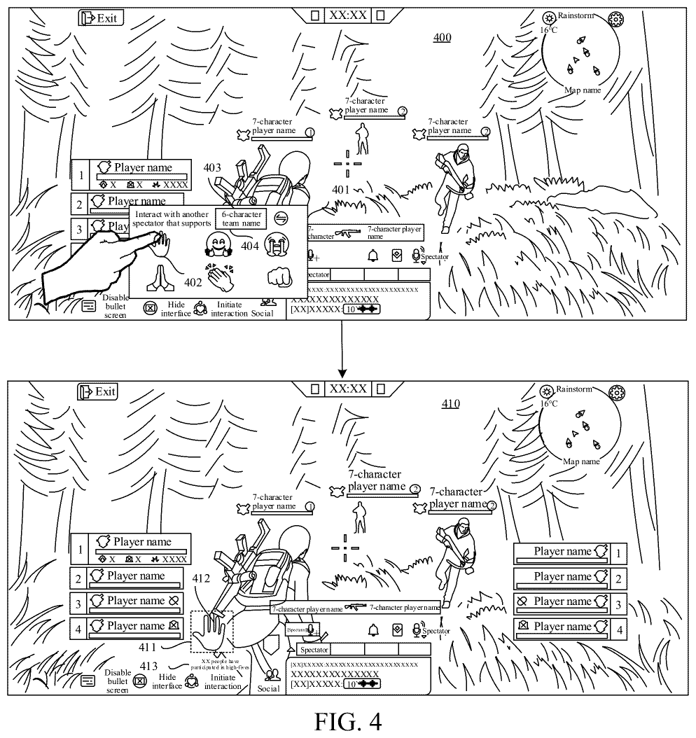

In an embodiment, at least one interactive action control is included in the interactive control. The interactive action control is configured to indicate an interactive action related to the first interactive content. Correspondingly, the trigger operation includes a trigger operation on the interactive action control. For example, referring to FIG. 4, an interactive pop-up window 401 is displayed in a spectator interface 400. The interactive pop-up window 401 includes a high-five action control 402. The high-five action control 402 can be clicked/tapped to initiate a high-five interaction, and high-five content 411 is displayed in a spectator interface 410.

In an embodiment, an interactive action is displayed in the first interactive content. The interactive action is associated with the first interactive content. For example, referring to FIG. 4, a high-five action 412 is displayed in the high-five content 411.

In some embodiments, a process of displaying the first interactive content further includes:
determining the first spectator set in response to receiving the trigger operation on the interactive control; and transmitting the first interactive content to the spectator account in the first spectator set. In other words, the manner of transmitting the first interactive content to the spectator account in the first spectator set after the first spectator set is determined can enable the first spectator account to interact with a specified spectator account in a spectator process, which enhances targeted interaction in a spectator process.

In an embodiment, the method for determining the first spectator set includes at least one of the following manners.
1. A first spectator group corresponding to the trigger operation is determined in response to receiving the trigger operation on the interactive control, the first spectator group corresponding to a first battling party in the online battle; and the first spectator set is determined from the first spectator group.

In an embodiment, the first battling party refers to at least one of the following cases.
Case 1: The first battling party refers to a battling party supported by the first spectator account. For example, in a case that the specified platform is implemented as an online game platform, there are a red team and a blue team in a battle in an online game, there is a rivalry between the two teams, and a spectator account in the first spectator group supports the red team, the red team is the first battling party.
Case 2: The first battling party refers to a battling party to which a player for which the first spectator account spectates belongs. For example, in a case that the specified platform is implemented as an online game platform, there are a red team and a blue team in a battle in an online game, and a spectator account in the first spectator group is in a perspective of the red team, the red team is the first battling party.
Case 3: The first battling party refers to a battling party to which an anchor watched by the first spectator account belongs. For example, in a case that the specified platform is implemented as a live match streaming platform, an anchor A is an account participating in a battle, and a spectator account in the first spectator group chooses to watch a live streaming of the anchor A, a team to which the anchor A belongs is the first battling party.

The foregoing cases of the first battling party are merely used as examples, and are not limited in this embodiment of this application.

In other words, the manner of first selecting a battling party, then selecting a spectator group corresponding to the battling party, and finally, determining the first spectator set from the spectator group can enable the first spectator account to perform spectator interaction with a spectator account that supports a same battling party, which improves the effectiveness of interaction.

In this embodiment, descriptions are provided by using an example in which the first battling party is a battling party supported by the first spectator account. The first spectator group refers to a group including all spectator accounts that support the first battling party.

In an embodiment, the interactive control further includes a switching control. The switching control is configured to switch a battling party supported by the first spectator account. Correspondingly, the trigger operation further includes a trigger operation on the switching control. The interactive control is further configured to display a name of a spectator party. Names of spectator parties can be displayed through the trigger operation on the switching control. A switching range of the spectator party is all battling parties participating in the online battle or all battle accounts participating the online battle. For example, referring to FIG. 4, the interactive pop-up window 401 includes a switching button 403. The interactive pop-up window 401 displays a team name 404, and the team name 404 can be switched by clicking/tapping the switching button 403.

In an embodiment, the first spectator account may determine the first battling party based on the trigger operation on the switching control, and further determine the first spectator group.

In some embodiments, the method for determining the first spectator set from the first spectator group further includes:
determining a candidate spectator account randomly from the first spectator group at a preset interaction ratio; and forming the first spectator set based on the candidate spectator account that is randomly determined.

In an embodiment, in response to determining the first spectator set at the preset interaction ratio, at least one of the following cases is included:
(1) A quantity of candidate spectator accounts is determined at the preset interaction ratio. In some embodiments, in a case that a product of the preset interaction ratio and a total quantity of spectator accounts in the first spectator group is a non-integer, the product is rounded up. For example, the preset interaction ratio is set to 10%. In a case that a quantity of accounts in the first spectator group is 4, a quantity of candidate spectator accounts is 1 (10% of 4 is 0.4, rounded up as 1). In a case that a quantity of accounts in the first spectator group is 1000, a quantity of candidate spectator accounts is 100. In a case that a quantity of accounts in the first spectator group is 998, a quantity of candidate spectator accounts is 100 (after being rounded up).
(2) In a case that a total quantity of spectator accounts in the first spectator group falls within a first quantity range, the first spectator set is determined according to a first interaction ratio. In a case that a total quantity of spectator accounts in the first spectator group falls within a second quantity range, the first spectator set is determined according to a second interaction ratio. There is no intersection between the first quantity range and the second quantity range. In addition, the first interaction ratio and the second interaction ratio are implemented as preset fixed ratios, or the first interaction ratio and the second interaction ratio are interaction ratios freely adjusted by a user.

For example, the first quantity range is from 0 to 50, and the first interaction ratio is 50%; and the second quantity range is from 51 to 1000, and the second interaction ratio is 20%. In a case that a quantity of accounts in the first spectator group is 40, a quantity of candidate spectator accounts is 20; and in a case that a quantity of accounts in the first spectator group is 200, a quantity of candidate spectator accounts is 40. In an embodiment, in a case that a product of the first second interaction ratio/second interaction ratio and a total quantity of spectator accounts in the first spectator group is a non-integer, the product is rounded up.
(3) In a case that a total quantity of spectator accounts in the first spectator group falls within a first quantity range, a candidate spectator account in the first spectator set is determined according to a preset quantity. In a case that a total quantity of spectator accounts in the first spectator group falls within a second quantity range, a candidate spectator account in the first spectator set is determined at a preset interaction ratio

For example, the first quantity range is from 0 to 100, and the preset quantity is 1; and the second quantity range is from 101 to 1000, and the preset interaction ratio is 10%. In a case that a quantity of accounts in the first spectator group is 40, a quantity of candidate spectator accounts is 1; and in a case that a quantity of accounts in the first spectator group is 200, a quantity of candidate spectator accounts is 20. In an embodiment, in a case that a product of the preset interaction ratio and a total quantity of spectator accounts in the first spectator group is a non-integer, the product is rounded up. In an embodiment, the candidate spectator account does not include a spectator account whose spectator interface displays interactive content at the display starting moment, or the candidate spectator account does not include a spectator account that has received interactive content.

In an embodiment, that the spectator account has received interactive content includes at least one of the following manners.
Manner 1: For example, in a battle, a historical interaction time is set. Timing starts once the spectator account receives new interactive content. In the historical interaction time, the spectator account can receive same interactive content only once. After the historical time, the spectator account can receive the same interactive content again.
Manner 2: For example, in a battle, during the course of the battle, once a spectator account receives new interactive content, the spectator account cannot receive same interactive content again.

In an embodiment, a corresponding quantity of candidate spectator accounts are randomly determined from the first spectator group, and a set formed by the corresponding quantity of candidate spectator accounts is the first spectator set.

In some embodiments, the candidate spectator account may also be determined at the preset interaction ratio from the first spectator group according to an interactive activity level of a spectator account, and the first spectator set is formed based on the determined candidate spectator account. In an embodiment, the interactive activity level includes a quantity of historical interaction responses, a quantity of historical interaction initiations, and the like. This is not limited in this embodiment. For example, a spectator account with a high interactive activity level is preferentially determined as a candidate spectator account.

In some optional embodiments, the candidate spectator account may also be determined at the preset interaction ratio from the first spectator group according to a spectator time of a spectator account, and the first spectator set is formed based on the determined candidate spectator account. In an embodiment, the spectator time refers to a spectator time of one battle or two or more battles. For example, a spectator account with a long spectator time is preferentially determined as a candidate spectator account.

In some embodiments, the candidate spectator account may also be determined at the preset interaction ratio from the first spectator group according to a sequence at which a spectator account enters the spectator interface, and the first spectator set is formed based on the determined candidate spectator account. For example, a spectator account that enters the spectator interface first is preferentially determined as a candidate spectator account.
2. The first spectator set is determined, in response to receiving the trigger operation on the interactive control, at a preset interaction ratio from a spectator account set of watching an online battle in real time.

In an embodiment, the spectator account set refers to all spectator accounts watching the online battle in real time. In an embodiment, the spectator account set does not include a spectator account whose spectator interface displays interactive content at the display starting moment.

In some optional embodiments, the method for determining the first spectator set from the spectator account set further includes:
determining a candidate spectator account randomly from the spectator account set at the preset interaction ratio; and forming the first spectator set based on the candidate spectator account that is randomly determined.

In an embodiment, a corresponding quantity of candidate spectator accounts are randomly determined from the spectator account set, and a set formed by the corresponding quantity of candidate spectator accounts is the first spectator set.

In other words, the preset interaction ratio is determined based on different methods, so that the candidate spectator account is determined randomly from a first spectator group to generate the first spectator set, which enables the first spectator account to interact with a specified quantity of spectator accounts that are selected randomly, and improves interaction randomness.

In some embodiments, the candidate spectator account may also be determined at the preset interaction ratio from the spectator account set according to an interactive activity level of a spectator account, and the first spectator set is formed based on the determined candidate spectator account. In an embodiment, the interactive activity level includes a quantity of historical interaction responses, a quantity of historical interaction initiations, and the like. This is not limited in this embodiment. For example, a spectator account with a high interactive activity level is preferentially determined as a candidate spectator account.

In some embodiments, the candidate spectator account may also be determined at the preset interaction ratio from the spectator account set according to a spectator time of a spectator account, and the first spectator set is formed based on the determined candidate spectator account. In an embodiment, the spectator time of the spectator account refers to a spectator time of one battle or two or more battles. For example, a spectator account with a long spectator time is preferentially determined as a candidate spectator account.

In some embodiments, the candidate spectator account may also be determined at the preset interaction ratio from the spectator account set according to a sequence at which a spectator account enters the spectator interface, and the first spectator set is formed based on the determined candidate spectator account. For example, a spectator account that enters the spectator interface first is preferentially determined as a candidate spectator account.

The method for determining the first spectator set is merely used as an example. This is not limited in this embodiment of this application.

In an embodiment, during display of the first interactive content, the first interactive content is transmitted to a spectator account in the first spectator set, and a first interaction request control is displayed in an interface of the spectator account in the first spectator set. The first interaction request control is associated with the first interactive content. In an embodiment, the first interaction request control includes a first interaction animation, an account name, and a prompt bubble. The first interaction animation is configured to display an animation of an interactive action related to the first interactive content. For example, in a case that an interactive action related to the first interactive content is a high-five, the first interaction animation is shown as a palm shaking left and right. The account name is configured to display a name of a spectator account that transmits an interaction request, that is, the account name of the first spectator account in this embodiment. The prompt bubble is configured to display text prompt information associated with the first interaction animation. For example, in a case that the interactive action related to the first interactive content is a high-five, the prompt bubble displays “High-five”.

In an embodiment, a spectator account in the first spectator set performs a trigger operation on the first interaction request control, and first participation content is displayed in a spectator interface of the spectator account. The first participation content displays the interactive action related to the first interactive content.

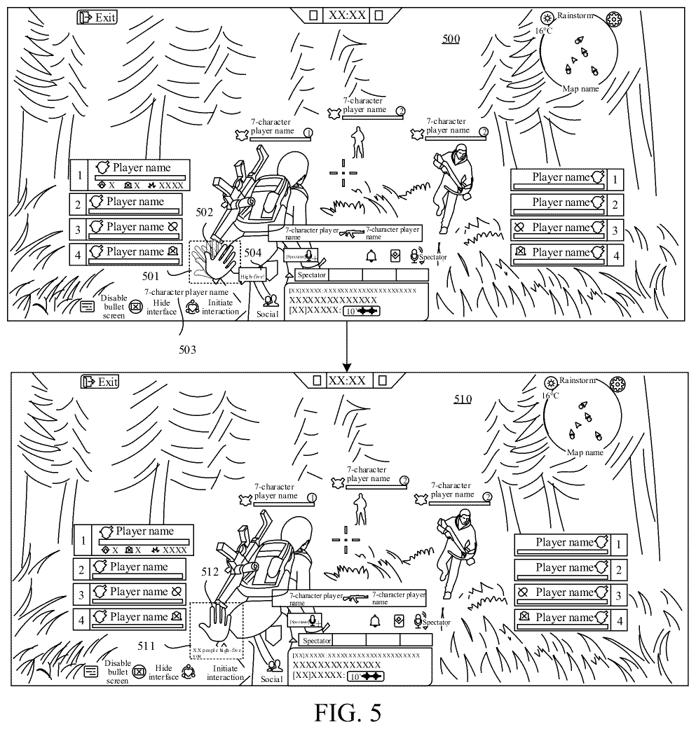

For example, referring to FIG. 5, a high-five request control 501 is displayed in a spectator interface 500, and includes: a high-five animation 502, a player name 503 and a bubble 504. In a case that the high-five animation 502 is clicked/tapped, high-five participation content 511 is displayed in a spectator interface 510, and a high-five action 512 is displayed in the high-five participation content 511.
Step 203: Display a quantity of interactive accounts based on the first interactive content. In an embodiment, a quantity of spectator accounts corresponding to the first interactive content is displayed. The quantity of spectator accounts includes one or more spectator accounts in the first spectator set that have interacted with the transmitted first interactive content and spectator accounts that have interacted with second interactive content triggered by a second spectator account between the display starting time point and the display ending time point. The second interactive content is a same interactive content type as the first interactive content.

The quantity of interactive accounts includes a first quantity of interactive accounts and a second quantity of interactive accounts. The first quantity of interactive accounts is a quantity of accounts that respond to the first interactive content in a process of displaying the first interactive content. The second quantity of interactive accounts is a quantity of accounts that respond to second interactive content between the display starting moment and the display ending moment. The second interactive content is display content triggered by a second spectator account between the display starting moment and the display ending moment. The second interactive content is transmitted to a spectator account in a second spectator set. An interaction form corresponding to the first interactive content is the same as an interaction form corresponding to the second interactive content.

In an embodiment, the first quantity of interactive accounts refers to a quantity of spectator accounts that perform the trigger operation on the first interaction request control in the first spectator set in the process of displaying the first interactive content.

In an embodiment, the second interactive content refers to display content triggered by a second spectator account between the display starting moment and the display ending moment. There may be one or two or more second spectator accounts. In other words, same display content triggered by a plurality of spectator accounts between the display starting moment and the display ending moment may all be referred to as the second interactive content. In an embodiment, the interaction form indicated by the second interactive content is the same as the interaction form indicated by the first interactive content.

In an embodiment, a method for determining a second spectator set is similar to the method for determining the first spectator set, which has been described in step 202, and details are not described herein again. In an embodiment, the second spectator set does not include spectator account whose spectator interface displays interactive content at a transmission moment of the corresponding second interactive content or a spectator account that has received interactive content.

In an embodiment, the second spectator set and the first spectator set both belong to the first spectator group, in other words, the second spectator set and the first spectator set both support the first battling party. Alternatively, the second spectator set and the first spectator set do not belong to a same spectator group, in other words, the second spectator set and the first spectator set support different battling parties.

In an embodiment, the second quantity of interactive accounts refers to a quantity of spectator accounts that perform a trigger operation on a second interaction request control in the corresponding second spectator set in a process of displaying second interactive content corresponding to different second spectator accounts.

In an embodiment, the first interactive content is also configured to display the quantity of interactive accounts. A manner of displaying the quantity of interactive accounts includes at least the following manners:
1. The first interactive content displays the quantity of interactive accounts in real time. For example, as shown in FIG. 4, a quantity 413 of accounts performing a high-five is displayed below the high-five action 412 in real time.
2. At the display ending moment, the first interactive content displays a quantity of interactive accounts between the display starting moment and the display ending moment.

The manner of displaying the quantity of interactive accounts is merely used as an example, and is not limited in this embodiment of this application.

To sum up, in the method provided in this embodiment, same interactive content displayed on spectator interfaces of different spectator accounts is transmitted to some spectator accounts, a quantity of spectator accounts that respond to the same interactive content in a period of time is counted, and a specified response result is displayed in the spectator interfaces based on the quantity of spectator accounts, which saves computing resources of the backend while implementing interaction sharing among different spectator accounts.

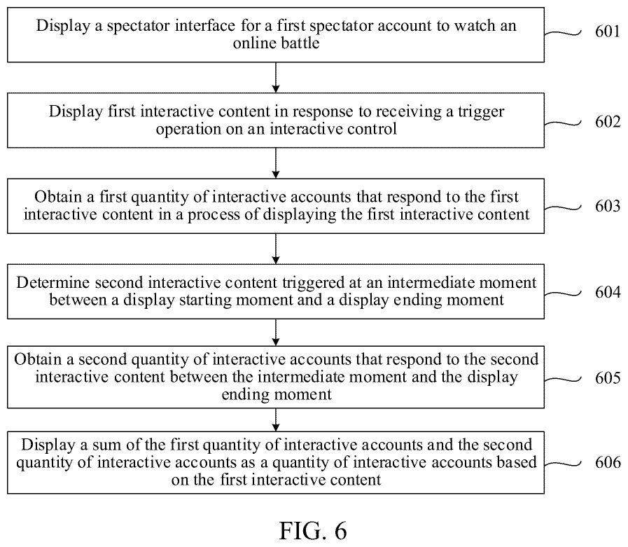

FIG. 6 is a flowchart of a spectator interaction method according to another exemplary embodiment of this application. As shown in FIG. 6, the method includes the following steps:
Step 601: Display a spectator interface for a first spectator account to watch an online battle.

The spectator interface includes an interactive control. The interactive control is configured to trigger an interaction with a spectator account that is watching the online battle.

The manner of displaying the spectator interface is described in details in step 201, and details are not described herein again.
Step 602: Display first interactive content in response to receiving a trigger operation on an interactive control.

The first interactive content corresponds to a display starting moment and a display ending moment. The first interactive content is display content transmitted to a spectator account in a first spectator set.

The method for determining the first spectator set and specific content of the first interactive content are described in step 202, and details are not described herein again.

In an embodiment, the first spectator account transmits an interaction request to a server while responding to the trigger operation. The interaction request includes the first interactive content. The server receives the interaction request from the first spectator account and forwards the first interactive content to the spectator account in the first spectator set.
Step 603: Obtain a first quantity of interactive accounts that respond to the first interactive content in a process of displaying the first interactive content.

In an embodiment, the process of displaying the first interactive content is from the display starting moment to the display ending moment. In other words, display of the first interactive content in the spectator interface starts from the display starting moment, and display of the first interactive content in the spectator interface ends in a case that the display ending moment is reached.

In an embodiment, in a case that spectator accounts that receive the first interactive content are all spectator accounts in the first spectator set, the first quantity of interactive accounts refers to a quantity of spectator accounts that respond to the first interactive content in the first spectator set.

For example, the spectator account in the first spectator set responds to the first interactive content through at least one of the following: a click/tap operation, a swipe operation, a voice operation, a press operation, and motion control (for example, shaking a screen).
Step 604: Determine second interactive content triggered at an intermediate moment between the display starting moment and the display ending moment.

In an embodiment, the second interactive content refers to display content triggered by a second spectator account at a specific moment between the display starting moment and the display ending moment. The second spectator account receives the first interactive content triggered by the first spectator account, but does not respond to the first interactive content, or the second spectator account does not receive the first interactive content triggered by the first spectator account.

In an embodiment, the first interactive content and the second interactive content belong to a same interaction form. For example, the first interactive content and the second interactive content both are high-five interactions.
Step 605: Obtain a second quantity of interactive accounts that respond to the second interactive content between the intermediate moment and the display ending moment.

In an embodiment, in a case that spectator accounts that receive the second interactive content are all spectator accounts in the second spectator set, the second quantity of interactive accounts refers to a quantity of spectator accounts that respond to the second interactive content in the second spectator set.

In an embodiment, there may be a plurality of second spectator accounts that trigger second interactive content between the display starting moment and the display ending moment. Each second spectator account corresponds to an intermediate moment (the intermediate moment refers to a moment at which display of the second interactive content starts). In other words, in addition to the first spectator account, there are the plurality of second spectator accounts that also transmit interactive content between the display starting moment and the display ending moment, and the interactive content transmitted by the plurality of second spectator accounts and the interactive content transmitted by the first spectator account belong to a same interaction solution. For example, the plurality of second spectator accounts and the first spectator account all trigger a same interactive emoticon. A quantity of spectator accounts that respond to the interactive content transmitted by the second spectator accounts from the display starting moment to the display ending moment is counted.

For example, the spectator account in the second spectator set responds to the second interactive content through at least one of the following: a click/tap operation, a swipe operation, a voice operation, a press operation, and motion control (for example, shaking a screen).
Step 606: Display a sum of the first quantity of interactive accounts and the second quantity of interactive accounts as a quantity of interactive accounts based on the first interactive content.

In an embodiment, at least the quantity of interactive accounts and an interaction solution corresponding to the first interactive content are displayed in the first interactive content.

In an embodiment, a manner of calculating the quantity of interactive accounts includes at least one of the following manners:
1. A sum of the first quantity of interactive accounts and the second quantity of interactive accounts is calculated to obtain the quantity of interactive accounts.

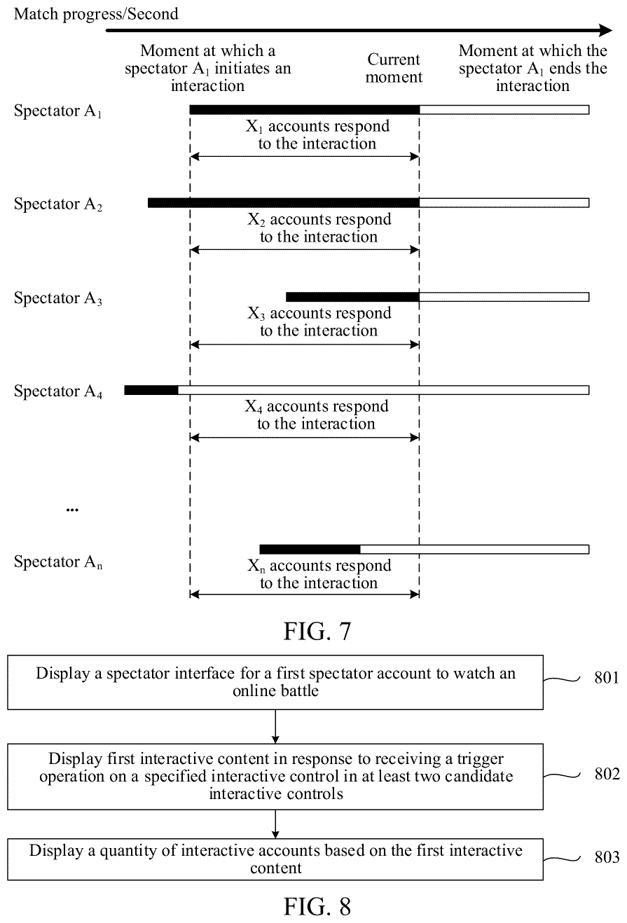

For example, referring to FIG. 7, in a match progress, an interaction initiating moment of a spectator A₁ is the display starting moment, and an interaction ending moment of the spectator A₁ is the display ending moment. In FIG. 7, a current moment is configured to display the quantity of interactive accounts in the spectator interface in real time. Logic of calculating a quantity of interactive accounts from the interaction initiating moment of the spectator A₁ to the current moment is the same as logic of calculating a quantity of interactive accounts from the interaction initiating moment of the spectator A₁ to the interaction ending moment of the spectator A₁. In other words, the current moment may be regarded as an interaction ending moment of the spectator A₁.

For example, in FIG. 7, the spectator A₁ to a spectator Aₙ represent spectators initiating an interaction, that is, spectator accounts transmitting interactive content. A black bar behind each spectator represents a quantity of accounts that respond to an interaction initiated by the spectator.

For example, to calculate a quantity of accounts that respond to interactive content of the spectator A₁ at the current moment, a quantity of accounts that respond to the interaction of the spectator A₁ from the interaction initiating moment to the current moment needs to be calculated and recorded as a first quantity X₁ of interactive accounts, a quantity of all accounts that respond to interactions of the spectator A₂ to the spectator Aₙ in a period of time from the interaction initiating moment of the spectator A₁ to the current moment also needs to be calculated, and recorded as a second quantity of interactive accounts X₂+X₃+X₄+ . . . +Xₙ. A quantity X_{A} of accounts that respond the interaction of the spectator A₁ at the current moment is obtained by adding up the first quantity of interactive accounts and the second quantity of interactive accounts.
2. In some embodiments, the quantity of interactive accounts includes a sum of the first quantity of interactive accounts and the second quantity of interactive accounts, and the quantity of interactive accounts further includes a quantity of second spectator accounts that trigger the second interactive content between the display starting moment and the display ending moment.

A sum of the first quantity of interactive accounts, the second quantity of interactive accounts, and the quantity of second spectator accounts is calculated to obtain the quantity of interactive accounts.

For example, to calculate a quantity of accounts that respond to interactive content of the spectator A₁ at the current moment, first, a quantity of accounts that respond to the interaction of the spectator A₁ from the interaction initiating moment to the current moment is calculated and recorded as a first quantity X₁ of interactive accounts, second, a quantity of all accounts that respond to interactions of the spectator A₂ to the spectator Aₙ in a period of time from the interaction initiating moment of the spectator A₁ to the current moment is calculated and recorded as the second quantity of interactive accounts X₂+X₃+X₄+ . . . +Xₙ, X_{A} being obtained by adding up the first quantity of interactive accounts and the second quantity of interactive accounts, and finally, as shown in FIG. 7, X_{A}+(n−1) is calculated, n−1 representing a quantity of other spectators initiating the interactions in the period of time from the interaction initiating moment of the spectator A₁ to the current moment, that is, the quantity of second spectator accounts triggering the second interactive content between the display starting moment and the display ending moment. In this case, X_{A}+(n−1) is the quantity of accounts that respond to the interaction of the spectator A₁ at the current moment. In other words, the quantity of second spectator accounts triggering the second interactive content is added to the quantity of interactive accounts, so that spectator accounts initiating a same form of interactive content as the first spectator account can also be regarded as accounts that respond to the interaction of the first spectator account, which expands a range of interaction responses.

In an embodiment, a manner of displaying the first quantity of interactive accounts and the second quantity of interactive accounts includes at least one of the following manners.
Manner 1: The first quantity of interactive accounts and the second quantity of interactive accounts are respectively displayed in the spectator interface. For example, two pieces of same high-five content, high-five 1 content and high-five 2 content, are displayed in a spectator interface of a spectator account A. “X people high-five you” is displayed below the high-five 1 content. X refers to a quantity of spectator accounts that respond to a high-five 1 action initiated by the spectator account A, that is, the first quantity of interactive accounts. “Y people also high-five you” is displayed below the high-five 2 content. Y refers to a quantity of spectator accounts that respond to a high-five 2 action initiated by another spectator account, that is, the second quantity of interactive accounts.
Manner 2: A sum of the second quantity of interactive accounts and the first quantity of interactive accounts is displayed in the spectator interface. For example, high-five content is displayed in the spectator interface, and “A total of Z people high-five you” is displayed below the high-five content. Z refers to the sum of the second quantity of interactive accounts and the first quantity of interactive accounts.

The manner of displaying the first quantity of interactive accounts and the second quantity of interactive accounts is merely used as an example, and is not limited in this embodiment of this application.

To sum up, in the method provided in this embodiment, same interactive content displayed on spectator interfaces of different spectator accounts is transmitted to some spectator accounts, a quantity of spectator accounts that respond to the same interactive content in a period of time is counted, a specified response result is displayed in the spectator interfaces based on the quantity of spectator accounts, which saves computing resources of the backend while implementing interaction sharing among different spectator accounts. In the method provided in this embodiment, in a case that the first interactive content and the second interactive content are interactive content in a same form, the sum of the first quantity of interactive accounts and the second quantity of interactive accounts is used as the quantity of interactive accounts that respond to the interaction of the first spectator account. Through a related calculation manner, interaction sharing is implemented among different spectator accounts sharing same interactive content. Further, quantities of interactive accounts of different spectator accounts are associated, which improves the interactive experience of the spectator accounts.

In the method provided in this embodiment, a quantity of second spectator accounts is added to the quantity of interactive accounts. Spectator accounts initiating interactions are associated, which further improves the interactive experience among the spectator accounts.

In the method provided in this embodiment, in a case that there are two pieces of interactive content in a same form in a same specified period of time, quantities of interactive accounts respectively responding to the two pieces of interactive content are obtained at the same time, which ensures that interactions initiated by different spectator accounts are synchronized, and further improves the spectator experience of the spectator accounts.

FIG. 8 is a flowchart of a spectator interaction method according to another exemplary embodiment of this application. As shown in FIG. 8, the method includes the following steps:
Step 801: Display a spectator interface for a first spectator account to watch an online battle.

The spectator interface includes an interactive control. The interactive control is configured to trigger an interaction between the first spectator account and a spectator account that is watching the online battle.

In an embodiment, a representation form of the interaction includes at least one of the following: an interactive signal (for example, a red alert), an interactive action (for example, a high-five action), an interactive voice message (for example, simple audio such as “Hello” or “Fall back”), and the like. This is not limited in this embodiment.

The manner of displaying the spectator interface is described in details in step 201, and details are not described herein again.

In some embodiments, the spectator interface includes at least two candidate interactive controls.

In an embodiment, the two candidate interactive controls trigger interactions with different content among spectator accounts. For example, one candidate interactive control is configured to trigger high-five interaction with a spectator account, and the other candidate interactive control is configured to trigger a cheering interaction with a spectator account.
Step 802: Display first interactive content in response to receiving a trigger operation on a specified interactive control in the at least two candidate interactive controls.

The specified interactive control refers to a candidate interactive control selected by the first spectator account.

In an embodiment, the first interactive content is associated with the specified interactive control.

In an embodiment, a manner of displaying the two candidate interactive controls includes at least one of the following manners:
1. The two candidate interactive controls are displayed in a superimposed manner. For example, the two candidate interactive controls are superimposed. In an embodiment, a user selects, through a swipe-left operation or a swipe-right operation, a sequence of superimposing the interactive controls, and may trigger a specified interactive control displayed on the top layer.
2. The two candidate interactive controls are displayed in the spectator interface side by side, and sizes of the two candidate interactive controls are basically the same. In an embodiment, a user selects and triggers a specified interactive control through a click/tap operation.
3. The two candidate interactive controls are displayed in the spectator interface side by side. In an embodiment, according to a time sequence of display, one candidate interactive control is selected and displayed in a normal size, and the other candidate interactive control is zoomed out and displayed. A trigger operation on the candidate interactive control that is zoomed out and displayed requires two steps: Step 1: Trigger the candidate interactive control the first time, to restore the candidate interactive control to a normal size. Step 2: Trigger the candidate interactive control to display interactive content. For example, a high-five interactive control is displayed in an interactive interface and has a size of 1 cm×1 cm, and a cheering interactive control is displayed in the interactive interface and has a size of 0.5 cm×0.5 cm. To trigger a high-five interaction, the high-five interactive control only needs to be clicked/tapped once, to trigger the high-five interaction. To trigger a cheering interaction, the cheering interactive control is clicked/tapped once to restore a size of the cheering interactive control to 1 cm×1 cm, and the cheering interactive control is clicked/tapped again, to trigger the cheering interaction.

A manner of displaying the two candidate interactive controls is merely used as an example, and is not limited in this embodiment of this application.
Step 803: Display a quantity of interactive accounts based on the first interactive content.

The quantity of interactive accounts includes a first quantity of interactive accounts and a second quantity of interactive accounts. The first quantity of interactive accounts is a quantity of accounts that respond to the first interactive content in a process of displaying the first interactive content. The second quantity of interactive accounts is a quantity of accounts that respond to second interactive content between the display starting moment and the display ending moment. The second interactive content is display content triggered by a second spectator account between the display starting moment and the display ending moment. The second interactive content is transmitted to a spectator account in a second spectator set. An interaction form corresponding to the first interactive content is the same as an interaction form corresponding to the second interactive content.

In an embodiment, display of the first interactive content is stopped in a case that the display ending moment is reached.

In an embodiment, the second interactive content is display content triggered by the second spectator account on the specified interactive control.

In some embodiments, a method for determining the display starting moment and the display ending moment includes at least one of the following methods:
1. A moment of triggering the interactive control by the first spectator account is used as the display starting moment. A preset display duration of the first interactive content is determined. The display ending moment is determined based on the display starting moment and the preset display duration.

In an embodiment, a manner of setting the preset display duration includes at least one of the following manners:
Manner 1: The preset display duration is directly set on the backend. In an embodiment, the preset display duration is fixed. In other words, the display of the first interactive content cannot be interrupted. The display of the first interactive content is stopped only in a case that the display ending moment is reached.
Manner 2: The spectator account sets the preset display duration on a terminal. Optionally, the spectator account may set display durations of different interactive content triggered by different interactive controls. In other words, the preset display durations of the different interactive content may be different.

For example, a preset display duration of a high-five interaction is 7 seconds. It is the 0^{th} second starting from a moment at which a high-five control is triggered to display high-five interactive content. At the 0^{th} second, display of the high-five interactive content is started in a spectator interface of a spectator account triggering the high-five control. Meanwhile, a spectator interface of another spectator account receiving the high-five interactive content starts to display a high-five request control. At the 7^{th} second, the display of the high-five interactive content and the display of the high-five request control are stopped at the same time.

In other words, the display duration is set in advance, so that calculation is started according to a moment of triggering the interactive control used as the display starting moment, and a final display ending moment is determined based on the display duration. An interaction process of the first interactive content can be implemented in a specified period of time, which improves the interaction efficiency.
2. A moment of triggering the interactive control by the first spectator account is used as the display starting moment. An interrupt operation is received in a process of displaying the first interactive content. A moment of triggering the interrupt operation is used as the display ending moment.

In other words, a display duration of the first interactive content is not limited. The display can be interrupted through an interrupt operation.

Optionally, the interrupt operation refers to at least one of the following cases.
Case 1: The first interactive content includes a close button, and the first spectator account may interrupt display of the first interactive content by triggering the close button.
Case 2: Display of the first interactive content is interrupted after the first spectator account exits the spectator interface. A method for exiting the spectator interface includes an active exit of the first spectator account or a passive exit of the first spectator account (for example, a crash of an application, a smartphone shutdown, and the like).
Case 3: The first spectator account triggers another interactive control, and display of the first interactive content is interrupted.

The foregoing cases of the interrupt operation are merely used as examples, and are not limited in this embodiment of this application.

Optionally, interaction between the first spectator account and another spectator account is stopped while the display of the first interactive content is stopped. For example, at the 0^{th} second, display of a high-five interactive content is started in a spectator interface of a spectator account triggering a high-five control. Meanwhile, a spectator interface of another spectator account receiving the high-five interactive content starts to display a high-five request control. In a case that the spectator account triggers a display ending operation, the display of the high-five interactive content and the display of the high-five request control are stopped at the same time.

In other words, after the display starting moment is determined, in a case that an interrupt operation is received in a process of displaying the first interactive content, a triggering moment corresponding to the interrupt operation is used as the display ending moment. An interaction process can be customized by a user, which improves the autonomous selectivity of the interaction process.
3. A moment of triggering the interactive control by the first spectator account is used as the display starting moment. A display duration of the first interactive content is timed through a timer starting from the display starting moment. In a case that the first interactive content receives a response from a spectator account, the timer is restarted for timing. A moment at which a required duration is reached is used as the display ending moment in response to that a timing duration of the timer reaches the required duration.

For example, at the 0^{th} second, display of a high-five interactive content is started in a spectator interface of a spectator account triggering the high-five control. Meanwhile, a spectator interface of another spectator account receiving the high-five interactive content starts to display a high-five request control, and timing a display duration of the high-five interactive content through a timer is started. A timing duration of the timer is set to 3 seconds. Each time a high-five response is received from another spectator account, the timer is restarted for timing. In a case the timer reaches 3 seconds, in other words, in 3 consecutive seconds, the spectator account does not receive a high-five response from another spectator account, the display of the high-five interactive content and the display of the high-five request control are stopped at the same time.

In other words, in a manner of setting the timer, display of the first interactive content is stopped in a case that there is no response from a spectator account in a required timing duration of the timer. In this way, the first interactive content is implemented as an interaction process with timeliness, which improves the interaction efficiency.

The display starting moment and the display ending moment are merely used as examples, and are not limited in this embodiment of this application.

More than one method for determining the display starting moment and the display ending moment described above is included in some optional embodiments.

For example, with reference to the manner 1 and the manner 3, in a case that the preset display duration is 7 seconds, and a timing duration of a timer is 3 seconds, at the 0^{th} second, display of a high-five interactive content is started in a spectator interface of a spectator account triggering a high-five control. Meanwhile, a spectator interface of another spectator account receiving the high-five interactive content starts to display a high-five request control, and timing a display duration of the high-five interactive content by the timer is started. In a case that the spectator account receives a high-five response from another spectator account in every 3 consecutive seconds from the 0^{th} second to the 7^{th} second, the display of the high-five interactive content and the display of the high-five request control are stopped at the same time at the 7^{th} second. In a case that the spectator account does not receive a high-five response from another spectator account in a period of 3 consecutive seconds from the 0^{th} second to the 7^{th} second, the display of the high-five interactive content and the display of the high-five request control are stopped at the same time at the end the period of 3 consecutive seconds.

The timing duration of the timer does not exceed the preset display duration.

For example, with reference to the manner 2 and the manner 3, in a case that the timing duration of the timer is 3 seconds, at the 0^{th} second, display of the high-five interactive content is started in a spectator interface of a spectator account triggering a high-five control. Meanwhile, a spectator interface of another spectator account receiving the high-five interactive content starts to display a high-five request control, and timing a display duration of the high-five interactive content by the timer is started. In a case that an interrupt operation is received or the timing duration of the timer reaches 3 seconds, the display of the high-five interactive content and the display of the high-five request control are stopped at the same time.

To sum up, in the method provided in this embodiment, same interactive content displayed on spectator interfaces of different spectator accounts is transmitted to some spectator accounts, a quantity of spectator accounts that respond to the same interactive content in a period of time is counted, a specified response result is displayed in the spectator interfaces based on the quantity of spectator accounts, which saves computing resources of the backend while implementing interaction sharing among different spectator accounts.

In the method provided in this embodiment, two pieces of interactive content may be displayed in the spectator interface through two candidate interactive controls. The first spectator account may perform two interactions at the same time, which enriches the interactive experience of the spectator account.

In the method provided in this embodiment, the first spectator set is determined at a preset interaction ratio. The first interactive content is forwarded to some spectator accounts, instead of all spectator accounts, in the first spectator set, which avoids a waste of backend resources due to repeated forwarding, and also avoids excessive interruption to the spectator account.

In the method provided in this embodiment, the display duration of the first interactive content is changed by changing the display ending moment, which facilitates the first spectator account performing another operation, reduces consumption of computer resources, and improves the user experience of the first spectator account.

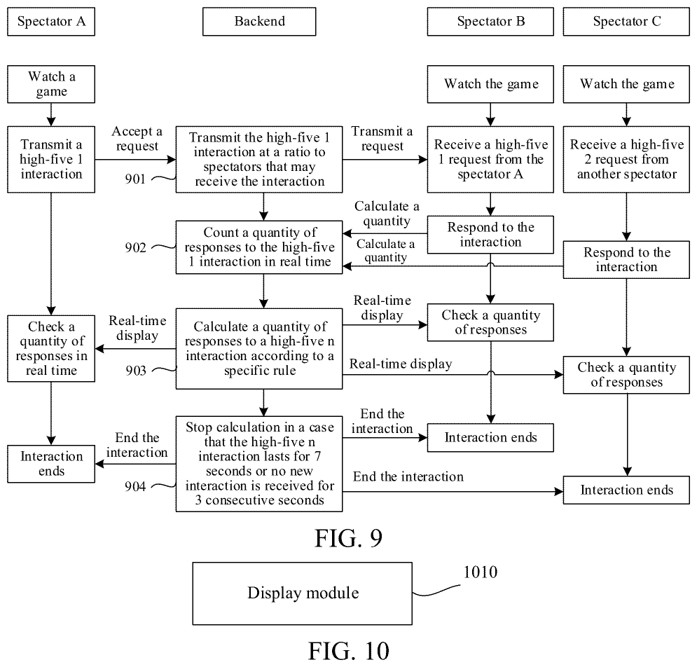

For example, refer to FIG. 9. FIG. 9 is a flowchart of logic of a spectator interaction method according to an embodiment of this application. As shown in FIG. 9, the following are provided:

A spectator A watches a game, and transmits a high-five 1 interaction in a spectator interface. A backend accepts a request from the spectator A, and transmits the high-five 1 interaction at a ratio to spectators that may receive the interaction. The spectators include a spectator B.

The spectator B is a spectator that watches the same game as the spectator A. The spectator B receives and responds to a high-five 1 request from the spectator A in a spectator interface, and transmits to a response result to the backend.

A spectator C also watches the same game as the spectator A. The spectator C receives and responds to a high-five 2 request from another spectator in a spectator interface, and transmits a response result to the backend. Interactive actions included in the high-five 1 request and the high-five 2 request are both high-five actions.

Based on the descriptions above, the following steps are performed in the backend:
Step 901: Transmit a high-five 1 interaction at a ratio to spectators that may receive the interaction.

In other words, the backend accepts the request from the spectator A, and transmits the high-five 1 interaction at a ratio to the spectators that may receive the interaction.
Step 902: Count a quantity of responses to the high-five 1 interaction in real time.

In other words, response results from the spectator B and the spectator C are counted.
Step 903: Calculate a quantity of responses to a high-five n interaction according to a specific rule.

For example, the spectator A transmits a high-five 1 interaction once. X1 spectators respond to the interaction in the first 3 seconds, and X2 spectators respond to the interaction in the next 4 seconds. A spectator D that does not receive the high-five interaction initiated by the spectator A transmits a same high-five interaction at the 4^{th} second. In the first 4 seconds after the interaction is transmitted, Y1 spectators respond to the interaction, and Y2 spectators respond to the interaction in the next 3 seconds. Finally, the high-five interaction of the spectator A is considered to have a total of X1+X2+Y1+2−1 responses (+2 refers to two spectators initiating the high-five interactions, and −1 means excluding the spectator A since the spectator A cannot interact with the spectator A). The high-five interaction of the spectator D is considered to have Y1+Y2+X2+2−1 responses.
Step 904: Stop calculation in a case that the high-five n interaction lasts for 7 seconds or no new interaction is received for 3 consecutive seconds.

For example, the spectator A transmits a high-five 1 interaction once at the 0^{th} second. In a case that the spectator A receives a response from another spectator in every 3 consecutive seconds from the 0^{th} second to the 7^{th} second, the interaction is ended at the 7^{th} second. In a case that the spectator account does not receive a response from another spectator in a period of 3 consecutive seconds from the 0^{th} second to the 7^{th} second, the interaction is ended at the end of the period of 3 consecutive seconds.

Refer to FIG. 10. FIG. 10 is a structural block diagram of a spectator interaction apparatus according to an exemplary embodiment of this application. The apparatus includes:
a display module 1010, configured to display a spectator interface for a first spectator account to watch an online battle, the spectator interface including an interactive control, the interactive control being configured to trigger an interaction between the first spectator account and a spectator account currently watching the online battle.

The display module 1010 is further configured to display first interactive content in response to receiving a trigger operation on the interactive control, the first interactive content corresponding to a display starting moment and a display ending moment, and the first interactive content being display content transmitted to a spectator account in a first spectator set.

The display module 1010 is further configured to display a quantity of interactive accounts based on the first interactive content, the quantity of interactive accounts including a first quantity of interactive accounts and a second quantity of interactive accounts, the first quantity of interactive accounts being a quantity of accounts that respond to the first interactive content in a process of displaying the first interactive content, and the second quantity of interactive accounts being a quantity of accounts that respond to second interactive content between the display starting moment and the display ending moment, the second interactive content being display content triggered by a second spectator account between the display starting moment and the display ending moment, and the second interactive content being transmitted to a spectator account in a second spectator set, an interaction form corresponding to the first interactive content being the same as an interaction form corresponding to the second interactive content.

In some optional embodiments, the display module 1010 is further configured to display a sum of the first quantity of interactive accounts and the second quantity of interactive accounts as the quantity of interactive accounts based on the first interactive content.

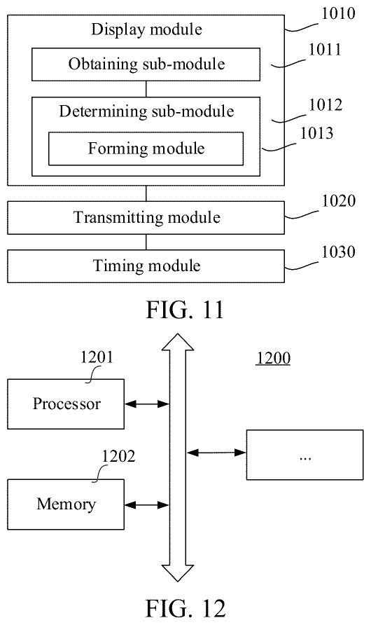

Referring to FIG. 11, in some possible embodiments, the display module 1010 further includes:
an obtaining sub-module 1011, configured to obtain the first quantity of interactive accounts that respond to the first interactive content in the process of displaying the first interactive content; and
a determining sub-module 1012, configured to determine the second interactive content triggered at an intermediate moment between the display starting moment and the display ending moment.

The obtaining sub-module 1011 is further configured to obtain the second quantity of interactive accounts that respond to the second interactive content between the intermediate moment and the display ending moment.

In some optional embodiments, the determining sub-module 1012 is further configured to determine the first spectator set in response to receiving the trigger operation on the interactive control.

The apparatus further includes:
a transmitting module 1020, configured to transmit the first interactive content to a spectator account in the first spectator set.

In some optional embodiments, the determining sub-module 1012 is further configured to determine, in response to receiving the trigger operation on the interactive control, a first spectator group corresponding to the trigger operation. The first spectator group corresponds to a first battling party in the online battle.

The determining sub-module 1012 is further configured to determine the first spectator set from the first spectator group.

In some optional embodiments, the determining sub-module 1012 is further configured to determine a candidate spectator account randomly from the first spectator group at a preset interaction ratio.

The determining subunit module 1012 includes further includes
a forming module 1013, configured to forming the first spectator set based on the candidate spectator accounts that are randomly determined.

In some optional embodiments, the spectator interface includes at least two candidate interactive controls. The display module 1010 is further configured to display the first interactive content in response to receiving a trigger operation on a specified interactive control in the at least two candidate interactive controls. The specified interactive control refers to a candidate interactive control selected by the first spectator account.

The second interactive content refers to display content triggered by the second spectator account on the specified interactive control.

In some optional embodiment, the quantity of interactive accounts further includes a quantity of second spectator accounts that trigger the second interactive content between the display starting moment and the display ending moment.

In some optional embodiments, the determining sub-module 1012 is further configured to use a moment of triggering the interactive control by the first spectator account as the display starting moment.

The determining sub-module 1012 is further configured to determine a preset display duration of the first interactive content.

The determining sub-module 1012 is further configured to determine the display ending moment based on the display starting moment and the preset display duration.

In some optional embodiments, the determining sub-module 1012 is further configured to use a moment of triggering the interactive control by the first spectator account as the display starting moment.

The determining sub-module 1012 is further configured to receive an interrupt operation in the process of displaying the first interactive content.

The determining sub-module 1012 is further configured to use a moment of triggering the interrupt operation as the display ending moment.

In some optional embodiments, the determining sub-module 1012 is further configured to use a moment of triggering the interactive control by the first spectator account as the display starting moment.

The apparatus further includes:
a timing module 1030, configured to time a display duration of the first interactive content through a timer starting from the display starting moment, the timer being restarted for timing in a case that the first interactive content receives a response from a spectator account.

The determining sub-module 1012 is further configured to use, in response to that a timing duration of the timer reaches a required duration, a moment at which the required duration is reached as the display ending moment.

The spectator interaction apparatus provided in the foregoing embodiments is merely illustrated with an example of division of functional modules. In practical application, the function distribution may be implemented by different functional modules according to requirements, that is, an internal structure of the device is divided into different functional modules, to implement all or some of the functions described above. In addition, the spectator interaction apparatus and the spectator interaction method embodiments provided in the foregoing embodiments belong to a same conception. For the specific implementation process, reference may be made to the method embodiments, and details are not described herein again.

FIG. 12 is a structural block diagram of a terminal 1200 according to an exemplary embodiment of this application. The terminal 1200 may be: a smartphone, a tablet computer, a Moving Picture Experts Group Audio Layer III (Moving Picture Experts Group Audio Layer III, MP3) player, and a Moving Picture Experts Group Audio Layer IV (Moving Picture Experts Group Audio Layer IV, MP4) player, a notebook computer or a desktop computer. The terminal 1200 may also be referred to as another name such as user equipment, a portable terminal, a laptop terminal, or a desktop terminal, or the like.

Generally, the terminal 1200 includes a processor 1201 (processing circuitry) and a memory 1202 (non-transitory computer-readable storage medium).

The processor 1201 may include one or more processing cores. For example, the processor 1201 may be a 4-core processor or an 8-core processor. The processor 1201 may be implemented in at least one hardware form of a digital signal processor (Digital Signal Processor, DSP), a field-programmable gate array (Field Programmable Gate Array, FPGA), and a programmable logic array (Programmable Logic Array, PLA). The processor 1201 may further include a main processor and a co-processor. The main processor is a processor configured to process data in an awake state, also referred to as a central processing unit (Central Processing Unit, CPU). The co-processor is a low power consumption processor configured to process data in a standby state. In some embodiments, the processor 1201 may be integrated with a graphics processing unit (Graphics Processing Unit, GPU), which is responsible for rendering and drawing content required to be displayed by a display screen. In some embodiments, the processor 1201 may further include an artificial intelligence (Artificial Intelligence, AI) processor, which is configured to process a computing operation related to machine learning.

The memory 1202 may include one or more non-transitory computer-readable storage media. The computer-readable storage media may be non-transitory. The memory 1202 may further include a high-speed random access memory, and a non-volatile memory, such as one or more magnetic disk storage devices and a flash storage device. In some embodiments, the non-transitory computer-readable storage medium in the memory 1202 is configured to store at least one instruction, and the at least one instruction being configured to be executed by the processor 1201 to implement the spectator interaction method provided in the method embodiments of this application.

For example, the terminal 1200 further includes another component. A person skilled in the art may understand that the structure shown in FIG. 12 constitutes no limitation on the terminal 1200, and the terminal may include more or fewer components than those shown in the figure, or some components may be combined, or a different component deployment may be used.

A person of ordinary skill in the art may understand that all or some of the steps of the various methods in the foregoing embodiments may be implemented by a program instructing relevant hardware. The program may be stored in a computer-readable storage medium. The computer-readable medium may be included in the electronic device described in the foregoing embodiments, or may exist alone and is not assembled in the electronic device. The computer-readable storage medium stores at least one instruction, at least one program, a code set or an instruction set, the at least one instruction, the at least one program, the code set or the instruction set being loaded and executed by the processor to implement the spectator interaction method according to any one of the embodiments.

Optionally, the computer-readable storage medium may include: a read-only memory (Read Only Memory, ROM), a random access memory (Random Access Memory, RAM), a solid state drive (Solid State Drives, SSD), an optical disc, or the like. The RAM may include a resistance random access memory (ReRAM, Resistance Random Access Memory) and a dynamic random access memory (DRAM, Dynamic Random Access Memory). The sequence numbers of the foregoing embodiments of this application are merely for description purpose, and do not indicate the preference among the embodiments.

What is claimed is:

1. A spectator interaction method, comprising:
displaying an interactive control for a first spectator account watching an online battle, the interactive control being configured to trigger an interaction between the first spectator account and one or more spectator accounts currently watching the online battle;
displaying first interactive content in response to receiving a trigger operation on the interactive control, the first interactive content having a display starting time point and a display ending time point, wherein the first interactive content is configured to be transmitted to the one or more spectator accounts in a first spectator set; and
displaying a quantity of spectator accounts corresponding to the displayed first interactive content, the quantity of spectator accounts including one or more spectator accounts in the first spectator set that have interacted with the transmitted first interactive content and spectator accounts that have interacted with second interactive content triggered by a second spectator account between the display starting time point and the display ending time point, the second interactive content being a same interactive content type as the first interactive content.

2. The method according to claim 1, wherein the displaying the quantity of spectator accounts comprises:
displaying a sum of a first quantity indicating the one or more spectator accounts in the first spectator set that have interacted with the transmitted first interactive content and a second quantity indicating the spectator accounts that have interacted with second interactive content.

3. The method according to claim 2, further comprising:
obtaining the first quantity;
determining the second interactive content triggered at an intermediate time point between the display starting time point and the display ending time point; and
obtaining the second quantity of the spectator accounts that have interacted with the second interactive content between the intermediate time point and the display ending time point.

4. The method according to claim 1, further comprising:
determining the first spectator set in response to receiving the trigger operation on the interactive control; and
transmitting the first interactive content to the one or more spectator accounts in the first spectator set.

5. The method according to claim 4, wherein the determining the first spectator set comprises:
in response to receiving the trigger operation on the interactive control, determining a first spectator group corresponding to the trigger operation, the first spectator group supporting a first battling party in the online battle; and
determining the first spectator set from the first spectator group.

6. The method according to claim 5, wherein the determining the first spectator set comprises:
determining a candidate spectator account randomly from the first spectator group at a preset interaction ratio; and
forming the first spectator set based on the candidate spectator account that is randomly determined.

7. The method according to claim 1, wherein
the interactive control comprises at least two candidate interactive controls;
the displaying the first interactive content comprises displaying the first interactive content in response to receiving a trigger operation on a specified interactive control in the at least two candidate interactive controls, the specified interactive control referring to a candidate interactive control selected by the first spectator account, and
the second interactive content is display content triggered by the second spectator account on the specified interactive control.

8. The method according to claim 1, wherein
the quantity of spectator accounts further comprises a quantity of second spectator accounts that trigger the second interactive content between the display starting time point and the display ending time point.

9. The method according to claim 1, further comprising:
using a time point when the interactive control is triggered by the first spectator account as the display starting time point;
determining a preset display duration of the first interactive content; and
determining the display ending time point based on the display starting time point and the preset display duration.

10. The method according to claim 1, further comprising:
using a time point when the interactive control is triggered by the first spectator account as the display starting time point;
receiving an interrupt operation in during displaying the first interactive content; and
using a time point of triggering the interrupt operation as the display ending time point.

11. The method according to claim 1, further comprising:
using a time point of triggering the interactive control by the first spectator account as the display starting time point;
timing a display duration of the first interactive content through a timer starting from the display starting time point, the timer being restarted in response to a determination that the first interactive content receives a response from a spectator account; and
when a timing duration of the timer reaches a required duration, setting a time point when the required duration is reached as the display ending time point.

12. A spectator interaction apparatus, comprising:
processing circuitry configured to
display an interactive control for a first spectator account watching an online battle, the interactive control being configured to trigger an interaction between the first spectator account and one or more spectator accounts currently watching the online battle;
display first interactive content in response to receiving a trigger operation on the interactive control, the first interactive content having a display starting time point and a display ending time point, wherein the first interactive content is configured to be transmitted to the one or more spectator accounts in a first spectator set; and
display a quantity of spectator accounts corresponding to the displayed first interactive content, the quantity of spectator accounts including one or more spectator accounts in the first spectator set that have interacted with the transmitted first interactive content, and spectator accounts that have interacted with second interactive content triggered by a second spectator account between the display starting time point and the display ending time point, the second interactive content being a same interactive content type as the first interactive content.

13. The apparatus according to claim 12, wherein the processing circuitry is further configured to:
display a sum of a first quantity indicating the one or more spectator accounts in the first spectator set that have interacted with the transmitted first interactive content and a second quantity indicating the spectator accounts that have interacted with second interactive content.

14. The apparatus according to claim 13, wherein the processing circuitry is further configured to:
obtain the first quantity;
determine the second interactive content triggered at an intermediate time point between the display starting time point and the display ending time point; and
obtain the second quantity of the spectator accounts that have interacted with the second interactive content between the intermediate time point and the display ending time point.

15. The apparatus according to claim 12, wherein the processing circuitry is further configured to:
determine the first spectator set in response to receiving the trigger operation on the interactive control; and
transmit the first interactive content to the one or more spectator accounts in the first spectator set.

16. The apparatus according to claim 15, wherein the processing circuitry is further configured to:
in response to receiving the trigger operation on the interactive control, determine a first spectator group corresponding to the trigger operation, the first spectator group supporting a first battling party in the online battle; and
determine the first spectator set from the first spectator group.

17. The apparatus according to claim 16, wherein the processing circuitry is further configured to:
determine a candidate spectator account randomly from the first spectator group at a preset interaction ratio; and
form the first spectator set based on the candidate spectator account that is randomly determined.

18. The apparatus according to claim 12, wherein
the interactive control comprises at least two candidate interactive controls;
the processing circuitry is further configured to display the first interactive content in response to receiving a trigger operation on a specified interactive control in the at least two candidate interactive controls, the specified interactive control referring to a candidate interactive control selected by the first spectator account, and
the second interactive content is display content triggered by the second spectator account on the specified interactive control.

19. The apparatus according to claim 12, wherein
the quantity of spectator accounts further comprises a quantity of second spectator accounts that trigger the second interactive content between the display starting time point and the display ending time point.

20. A non-transitory computer-readable storage medium storing computer-readable instructions thereon, which, when executed by processing circuitry, cause the processing circuitry to perform a spectator interaction method comprising:
displaying an interactive control for a first spectator account watching an online battle, the interactive control being configured to trigger an interaction between the first spectator account and one or more spectator accounts currently watching the online battle;
displaying first interactive content in response to receiving a trigger operation on the interactive control, the first interactive content having a display starting time point and a display ending time point, wherein the first interactive content is configured to be transmitted to the one or more spectator accounts in a first spectator set; and
displaying a quantity of spectator accounts corresponding to the displayed first interactive content, the quantity of spectator accounts including one or more spectator accounts in the first spectator set that have interacted with the transmitted first interactive content and spectator accounts that have interacted with second interactive content triggered by a second spectator account between the display starting time point and the display ending time point, the second interactive content being a same interactive content type as the first interactive content.
